(19) United States
(12) Patent Application Publication
(10) Pub. No.: US 2016/0135468 A1
(43) Pub. Date: May 19, 2016

(54) A Composition for Enhanced Biocidal Activity and Water Purification Device on the Same

(71) Applicant: INDIAN INSTITUTE OF TECHNOLOGY, State of Tamil Nadu (IN)

(72) Inventors: Thalappil Pradeep, Chennai (IN); Mohan Udhaya Sankar, Chennai (IN); Chaudhary Amrita, Chennai (IN); Aigal Sahaja, Chennai (IN); ANSHUP N/N, Chennai (IN); J. Ravindran Swathy, Chennai (IN)

(21) Appl. No.: 14/900,740

(22) PCT Filed: Jun. 27, 2014
(86) PCT No.: PCT/IB14/02316

§ 371 Date: Dec. 22, 2015

(30) Foreign Application Priority Data
Jun. 28, 2013 (IN) 2867CHE2013

(51) Int. Cl. A01N 59/16; C02F 1/50; A01N 59/20

(52) U.S. Cl. CPC A01N 59/16; A01N 59/20; C02F 1/505; C02F 2303/04

(57) ABSTRACT

A composition for the purification of water and the device using the composition, where the composition contains a transition metal ion Mⁿ⁺ releasing compound along with an CO₃²⁻ releasing compound or an SiO₃²⁻ releasing compound.

### CROSS-REFERENCE TO RELATED APPLICATIONS

This application claims priority to Indian Application No. 2867/CHE/2013, filed on Jun. 28, 2013, which is incorporated herein by reference in its entirety.

### FIELD OF INVENTION

The present invention relates to a water purification devices and a composition used in water purification devices. More specifically, the present invention relates to a multi-component composition containing transition metal Mⁿ⁺ and CO₃²⁻ or Mⁿ⁺ and SiO₃²⁻ for disinfection of water.

### BACKGROUND OF THE INVENTION

The use of silver for water purification is one of the oldest known technologies and it dates back to 500 BC. Use of silver vessels for boiling, storage and food consumption was prevalent in the past. Silver is a wide-range disinfectant and its probable use as a medicine is part of several historical documents. A recent review covers the importance of silver in water purification (Pradeep T, Anshup, Thin Solid Films, 2009, 517, 24, 6441-6478).

Anti-bacterial properties of silver are interestingly designed by nature. Amongst several transition metal ions that are usually found in nature, silver ion is the only example which has its chloride salt highly insoluble in water (solubility=1.9 mg/L at 25° C.). This solubility limit is seemingly designed for a specific reason: to reduce the silver concentration in water, which limits the mobility of silver in living bodies.

With high degree of certainty, it can be stated that biocidal property of silver is the highest researched subject of water purification. There are several mechanisms associated with the biocidal property of silver and copper and is covered in several recent articles (Pradeep T, Anshup, Thin Solid Films, 2009, 517, 24, 6441-6478; Feng QL et al, J Biomed Mater Res., 2000, 52, 662-668; Z. Xiu et al, Nano Lett., 2012, 12, 4271-4275). While the direct use of silver in ionic form was prevalent during the early part of last century, over a period of time, it has been replaced with in-situ silver ion formation through dissolution of zerovalent silver (such as silver nanoparticles and silver electrode, wherein the use of former as a source of ion is very popular for water purification).

It has recently been learnt through several detailed studies that dissolution of silver nanoparticles is negatively affected by the presence of salts in water (Hoek et al. J Nanopart Res. 2010, 12, 1531, Hoek et al. Environ. Sci. Technol. 2010, 44, 7321, Bonzongo et al. Environ. Sci. Technol. 2009, 43, 3322 and Lead et al. Environ. Sci. Technol. 2009, 43, 7285). Presence of natural organic matter also reduces the toxicity of biocides (Day et al, Environmental Technology 1997, 18, 781-794). The problem of negative effect of various salts and other species in water on silver ion dissolution from silver nanoparticles was overcome through the dispersion of silver nanoparticles in an organic templated metal oxyhydroxide composite (Indian patent application 947/CHE/2011, PCT/IB2012/001079 by the same inventors hereof).

It is also important to note that silver ions' microbial activity is severely affected by the presence of various species in water. For example, in ground water containing typical ions, silver ion concentration beyond the range of 65 ppb will precipitate as AgCI(s) and thus phase separate from water (detailed explanation is given in a subsequent section). This kind of property is also evident for other transition metal ions with varying degree of solubility in water. It is also to be noted that with increasing salt content of drinking water sources, available silver ions keep reducing as it starts to speciate as lesser potent silver complexes (e.g., AgCl₂⁻) (detailed explanation is given in a subsequent section). Similarly, silver ion is known to form complexes with organic species present in water. It is therefore understood that silver ion as an antimicrobial agent is severely affected by the presence of other ions and species in drinking water. Similarly, other transition metals also suffer from similar difficulties imposed by various species present in water. It is therefore important to develop new antimicrobial compositions containing transition metal ions; in particular, silver ion, which can provide disinfection ability in diverse conditions of water quality.

Antimicrobial activity of various transition metals is well-reported in the literature. Silver and copper have been of special interest, largely because they have no known long-term health effect on humans at the concentrations of use as well as their large disinfection potential. However, other transition metals are not so effective disinfectants, especially with regards to enteric microorganisms (Muller H E, Zentralbl Bakteriol Mikrobiol Hyg B., 1985, 182, 95-101). Anti-bacterial effect of transition metals is usually named as oligodynamic effect, as they are most effective at low concentrations (because of solubility limits imposed by various anions, they cannot exist as ions at higher concentrations in real water). It is suggested that toxicity of metal ions for fungi goes in the following order: Ag >Hg >Cu >Cd >Cr >Ni >Pb >Co >Au >Zn >Fe >Mn >Mo > and Sn (Martin, H. 1969. In D. C. Torge-son (ed.), Fungicides, vol. 11. Academic Press Inc., New York).

While the precise mechanism of silver ion attack on bacteria is not known, based on its known strong binding with sulphur, it is suggested that silver binds with sulphur containing enzymes and proteins (Bragg P D, Rainnie D J, Can J Microbiol., 1974, 20, 883-9). Interaction of silver with other components in the bacterial cell membrane through release of K⁺ ion or through hydrogen bonding is also suggested (Schreurs W J, Rosenberg H, J Bacteriol., 1982, 152, 7-13). It is difficult to ascertain the precise mechanism of silver's antimicrobial activity because most of such studies are conducted at higher silver ion concentrations at which it may undergo precipitation through interaction with cellular sulphur containing compounds. Conducting studies at low concentrations of silver is quite important for mechanism but requires significant experimental care.

Based on various mechanisms suggested in the literature so far, it is certain that silver interacts with sulphur containing compounds as well as negatively charged sites for metal ion binding. For the sake of simplicity and similarity with the concept of adsorption for water purification, silver ion may be addressed as adsorbate and microorganism as adsorbent. Adsorption of adsorbate on adsorbent is known to be interfered due to the presence of interfering species present in water. For example, adsorption of fluoride (F) on activated alumina is negatively affected by the presence of various negatively charged ions present in water e.g., CO₃²⁻, PO₄³⁻, HCO₃⁻, etc. It is therefore expected that adsorption of silver ion (adsorbate) on the microorganism (adsorbent) is negatively affected by the concentration of available silver as well as other ions/species present in water competing for the adsorption sites. Available silver continues to decrease with increasing concentration of Cl⁻ in water.

Availability of appropriate sites for adsorption is important for effective antibacterial activity. One study has shown the relevance of lipopolysaccharide (LPS)-cation interaction with bacteria to demonstrate how the resistance to microorganisms originates (E. Schneck, J R Soc Interface, 2009, 6, 5671-5678; E. Schneck, PNAS, 2010, 107, 20, 9147-9151). LPS is a major polysaccharide present in the outer membrane of gram-negative bacteria and therefore interacts with the external environment. It is suggested that Ca²⁺ forces the replacement of K⁺ ion from the negatively charged LPS and leads to the aggregation of O-side chain in LPS. With reduced surface energy, sites become inaccessible for biocidal species to enforce bactericidal action. It is important to note that concentration of biocides is significantly low (in ppb level) which limits their availability to microorganisms. This is reflected in several studies in the past such as, Brock T D, Can J Microbiol., 1958, 4, 65-71; L T Hansen et al., in Int J Food Microbiol., 2001, 66, 3, 149-161.

A similar mechanism is at work with virus too. Virus is actually closer to metal nanoparticles in terms of its properties such as negative zeta potential at near neutral pH (especially for most of viruses found in animal kingdom), particle size in the vicinity of 30 nm and propensity to aggregate in real water. This is reflected in several studies, e.g., Floyd, R, Sharp D. G., Appl. Environ. Microbio., 1978, 35, 1084-1094. A number of species present in water are known to increase virus aggregation which may lead to poor viral inactivation efficiency of known disinfectants (Galasso G. J., Sharp, D. G., J. Bacteriol., 1965, 90, 4, 1138-1142).

To nullify the effect of interfering species so as to retain the antibacterial activity, still remains a concern.

Role of water soluble monovalent metal carbonates (for example, Na₂CO₃) in water purification is for alkalization and water softening (e.g., European patent application EP0812808B1). Prior art reports of using metal carbonates (such as partially soluble magnesium or calcium carbonate) along with transition metals of antibacterial activity for drinking water is limited to them being slow dissolving tablets as an indicator for volume of water passed (e.g., WO 2006/070953, WO 2013/046213).

It is learnt from prior art that the presence of various interfering species in water is a serious problem affecting the disinfection potential of wide range of biocides. It is an important need to identify a composition based on transition metal ions which provides robust antimicrobial activity even in presence of various species present in water. It is important to note that such a composition should be permitted for use in water, especially drinking water.

### SUMMARY OF THE INVENTION

An object of the present invention is to provide an effective, simple and cost-effective composition based on transition metal ions and more particularly silver and copper ions for obtaining a resilient antimicrobial activity even in presence of interfering species usually found in water.

Another object of the present invention is to develop a water purification device based on the composition. An object of such a device is to ensure constant release of ions from the composition in water, over a prolonged use.

Yet another object of the present invention is to demonstrate that disinfection ability of the composition is significantly affected in the absence of either of the ingredients which may be utilized as a marker for replenishment of the composition, when the said ingredient is depleted.

According to an embodiment of the disclosure, the invention provides a novel composition for purification of water by obtaining biocidal activity in water. The composition comprises a transition metal ion Mⁿ⁺ releasing compound along with either a CO₃²⁻ releasing compound or a SiO₃²⁻ releasing compound. The 5 ppm to 100 ppm CO₃²⁻ releasing compound is selected from Na₂CO₃ or K₂CO₃. The 5 ppm to 40 ppm SiO₃²⁻ releasing compound is selected from Na₂SiO₃ or K₂SiO₃. The transition metal is Mⁿ⁺ is silver ion (Ag⁺). The 5 ppb to 100 ppb transition metal ion Mⁿ⁺ releasing compound is selected from silver nitrate, silver acetate, silver fluoride, silver sulfate, or silver nitrate.

According to another embodiment of the disclosure, the invention provides a water purification device having a tank and a filtration unit present inside the tank. The filtration unit includes at least one filtration medium and a capsule. The filtration medium releases metal ions in the water. The capsule either releases CO₃²⁻ in the water, wherein CO₃²⁻ ion is released by the compound comprising Na₂CO₃ or K₂CO₃ or it releases SiO₃²⁻ ion in the water, wherein SiO₃²⁻ ion is released by the compound comprising Na₂SiO₃ or K₂SiO₃.

It is understood from prior art that a number of interfering species present in drinking water are significant deterrents to the biocidal action of several biocides. It is shown that the effect of several such interfering species on the antimicrobial activity of transition metals is strongly negative. Therefore, in the present patent disclosure, a composition containing Mⁿ⁺ and CO₃²⁻ and Mⁿ⁺ and SiO₃²⁻ (Mⁿ⁺ represent transition metal ions and more particularly, silver and copper ion), further abbreviated as Mⁿ⁺/CO₃²⁻ and Mⁿ⁺/SiO₃²⁻ which offers strong antimicrobial activity even in presence of interfering species, usually found in water have been demonstrated. Mⁿ⁺/CO₃²⁻ doesn't mean an inorganic compound composed of Mⁿ⁺ and CO₃²⁻ as Mⁿ⁺ and CO₃²⁻ are present in widely separated concentration window (e.g., typical required concentration of Mⁿ⁺ in Mⁿ⁺/CO₃²⁻ is in the range of 1-10 μM whereas typical required concentration of CO₃²⁻ is in the range of 100-1000 μM). Similar concentration range is valid for Mⁿ⁺/SiO₃²⁻ as well.

According to yet another embodiment, the present invention also describes the method of adding the composition to the water in such a way that a constant release of Mⁿ⁺/X²⁻ (X²⁻ refers to CO₃²⁻ or SiO₃²⁻) is obtained. The composition is thereby demonstrated for use as a water purification device.

According to yet another embodiment, the present invention also demonstrates that the killing efficiency of Mⁿ⁺/X²⁻ is significantly improved compared to the killing efficiency obtained with transition metal ions alone (more particularly silver and copper ion). This is demonstrated through a number of features:

1. Enhancement in contact time required for the obtaining 100% biocidal action.

2. Enhancement in ability to kill microorganisms in chloride rich water.

3. Enhancement in ability to kill microorganisms even with further reduced biocide concentration.

4. Enhancement in ability to kill microorganisms in humic acid rich water.

5. Enhancement in ability to kill gram-positive bacteria.

6. Enhancement in ability to maintain sterility of water for long periods of storage.

7. Enhancement in ability to kill higher concentration of microorganisms.

According to yet another embodiment, the present invention also demonstrates that the killing efficiency of the composition is affected in the case of depleted ingredient of the composition, which may be utilized as an indication to replenish the composition in a water purification device.

### BRIEF DESCRIPTION OF THE FIGURES

The accompanying figures, which are incorporated in and constitute a part of this specification, illustrate several aspects and together with the description serve to explain the principles of the invention.

FIG. 1 shows a schematic representation of a water purification device according to an illustrative embodiment of the disclosure.

FIG. 2 shows a speciation diagram of silver ion in synthetic challenge water, speciation diagram prepared by varying [Cl⁻] and keeping [Agₜₒₜₐₗ]=50 ppb, pH=7, temperature=25° C.;

FIG. 3 shows a speciation diagram of silver ion in synthetic challenge water, speciation diagram prepared by varying [Ag⁺] concentration and keeping [Cl⁻]=100 ppm, pH=7, temperature=25° C. (a) Total dissolved Ag⁺{Ag⁺+AgCl(aq.)+(AgCl)Cl⁻}, (b) Dissolved active Ag⁺, (c) Dissolved AgCl, (d) Dissolved (AgCl)Cl⁻ and (e) Precipitated AgCl;

FIG. 4 shows a speciation diagram of silver ion in synthetic challenge water, speciation diagram prepared by varying [CO₃²⁻] concentration and keeping [Ag⁺] added=50 ppb, [Cl⁻]=100 ppm, temperature=25° C., pH is varied according to pH of CO₃²⁻. (a) Active Ag⁺, (b) Dissolved AgCl, (c) Dissolved (AgCl)Cl⁻ and (d) Dissolved AgOH;

FIG. 5 shows the comparison of the antibacterial activity of the composition and Ag⁺ in sea salt containing water. (a) Bacterial input concentration, and (b) bacterial output concentration in presence of the composition (Ag⁺ (50 ppb)/ CO₃²⁻ (20 ppm)) and (c) bacterial output concentration in presence of Ag⁺ (50 ppb);

FIG. 6 shows comparison of the antibacterial activity of the composition prepared with varying concentration of Ag⁺ and CO₃²⁻. (a) [Ag⁺]=20 ppb, (b) [Ag⁺]=30 ppb and (c) [Ag⁺]=50 ppb. CO₃²⁻ (0 ppm) represents the performance data for silver ion, Synthetic challenge water was used for the studies;

FIG. 7 shows comparison of the antibacterial activity of the composition and Ag⁺ in varying concentration of humic acid. (a) Ag⁺ (50 ppb) and (b) composition (Ag⁺(50 ppb)/CO₃²⁻(20 ppm);

FIG. 8 shows rate of bacteria killing efficiency by Mⁿ⁺ and composition (Mⁿ⁺/CO₃²⁻), wherein Mⁿ⁺ represent d-block cations. Rate is measured at (a) 1 h, (b) 3 h and (c) 5 h;

FIG. 9 shows comparison of the antibacterial activity of the composition and Ag⁺ against S. aureus (MTCC 96). (a) Bacterial count after 1 h standing time with Ag⁺, (b) bacterial count after 1 h standing time with the composition (Ag⁺/CO₃²⁻) and (c) bacterial count after 24 h standing time with the composition (Ag⁺/CO₃²⁻) (a measurement of sterility of water after a period of storage);

FIG. 10 shows bacterial count after 24 h of standing time with (a) only Ag⁺, (b) the composition (Ag³⁰ /SiO₃²⁻) and (c) the composition (Ag³⁰ /CO₃²⁻);

FIG. 11 shows role of CO₃²⁻ in de-aggregating bacteriophage, MS2. Bacteriophage MS2 at (a) a concentration of 103 PFU/mL in de-ionized water, (b) in synthetic challenge water and (c) in synthetic challenge water containing 20 ppm CO₃²⁻;

FIG. 12 shows comparison of the antiviral activity of the composition prepared with varying concentrations of Ag⁺ and CO₃²⁻. (a) [Ag³⁰ ]=0 ppb, (b) [Ag⁺]=20 ppb, (c) [Ag⁺]=30 ppb and (d) [Ag⁺]=50 ppb. Trace [a] is to show that CO₃²⁻ by itself is not an important antimicrobial agent. Synthetic challenge water was used for studies;

FIG. 13 shows comparison of the antiviral activity of the composition prepared with varying concentrations of Ag⁺ and SiO₃²⁻. (a) [Ag⁺]=0 ppb, (b) [Ag⁺]=20 ppb, (c) [A⁺]=30 ppb and (d) [Ag⁺]=50 ppb. Trace [a] is to show that SiO₃²⁻ by itself is not an important antimicrobial agent. Synthetic challenge water was used for the studies;

FIG. 14 shows rate of virus killing efficiency for silver ion in the absence and presence of CO₃²⁻, (a) [CO₃²⁻]=20 ppm, (b) [Ag⁺]=50 ppb and (c) [Ag⁺]=50 ppb and [CO₃²⁻]=20 ppm. Synthetic challenge water was used for studies;

FIG. 15 shows virus killing efficiency of Ag⁺ in presence of CO₃²⁻ for higher virus concentration (a) Input virus concentration: 1×10⁶, 1×10⁵, 1×10⁴, and 1×10³ PFU/mL and (b) output virus concentration after treatment with [Ag³⁰ ]=50 ppb and [CO₃²⁻]=20 ppm. Studies were conducted in synthetic challenge water;

FIG. 16 shows virus killing efficiency by (a) Mⁿ⁺, (b) composition (M⁺/CO₃²⁻ and (c) composition (Mⁿ⁺/SiO₃²⁻), wherein Mⁿ⁺ represent d-block cations. Studies were conducted in synthetic challenge water; and

FIG. 17 shows performance of a water purification device containing Ag-OTBN (947/CHE/2011, by same inventors hereof) as the source of Ag⁺in the composition (Ag⁺/CO₃²⁻). (a) E. coli input concentration, (b) E. coli output concentration, (c) virus input concentration, and (d) virus output concentration. Inset of the figure shows output bacteria and virus count during the passage of 2500-3300 L.

### DETAILED DESCRIPTION OF THE INVENTION

The present invention can be understood more readily by reference to the following detailed description of the invention and the examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

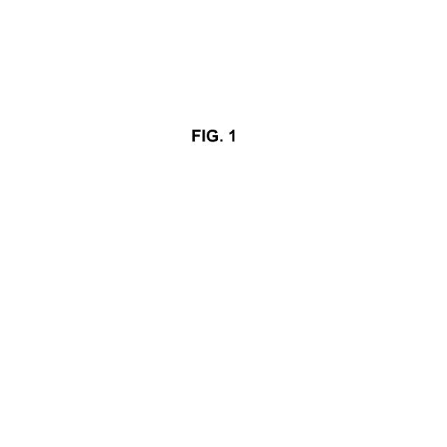

FIG. 1 shows the schematic representation of a water purification system 100 according to an embodiment of the invention. The water purification system 100 is configured to purify the water using transition metal ions along with CO₃²⁻ or SiO₃². The water purification system 100 includes a tank 102 and a filtration unit 104 present inside the tank. The tank 102 includes an inlet 106 and an outlet 108 for the passage of water inside and outside of the tank 102.

The filtration unit 104 further includes a filtration medium 110 and at least one capsule 112. The filtration medium 110 is configured to release the transition metal ion in the water. In an embodiment of the invention, the transition metal ion is silver ion. It should be appreciated that use of any other transition metal such as Fe³⁺, Zn ²⁺, Cu ²⁺ etc. is well within the scope of this invention. The metal ion is released by the compounds selected from the group comprising metal nitrate, metal acetate, metal fluoride, metal sulfate or metal nitrate. Though the use of silver is the most common in the art for purification of water. Going forward in this disclosure, the silver will be used generally for the sake of clarity. In an embodiment, the filtration medium 110 comprises silver nanoparticles impregnated on organic templated boehmite nanoarchitecture.

It should be appreciated that the source of silver ion is through dissolution of ion from silver releasing compound present in the form of silver nanoparticles. It should also be appreciated that the source of silver ion can also be through dissolution of ion from silver releasing compound present in the form of silver electrode.

The capsules 112 are housed in a see-through housing (not shown in Fig.) in the filtration unit 104. It should be appreciated that the capsules includes a plurality of a capsule. The capsule is configured to release CO₃²⁻ ion in the water or configured to release SiO₃²⁻ ion in the water. The CO₃²⁻ ion is released by the compound comprising Na₂CO₃ or K₂CO₃. The SiO₃² ion is released by the compound comprising Na₂SiO₃ or K₂SiO₃. The capsule is prepared by granulating finely ground Na₂CO₃.

According to an illustrative embodiment of the invention, a composition containing Mⁿ⁺/CO₃²⁻ or Mⁿ⁺/SiO₃²⁻ have been used for the purification of water. The composition described in the invention provides sterile drinking water for more than about 48 hours of storage. The composition acts as a biocide with water having chloride concentration up to 1000 ppm. The composition also provides antibacterial activity in water containing 5 times wider humic acid concentration range when compared with traditional use of Ag⁺.

The composition has various advantages over the traditionally used silver ion. The composition lowers the concentration of silver ion required at least by 50% when compared to traditional use of silver ion for obtaining antibacterial activity. The composition lowers the concentration of silver ion required at least by 60% when compared to traditional use of Ag⁺ for obtaining complete virus deactivation efficiency. The composition also lowers the standing time required for obtaining complete microbial deactivation efficiency at least by 50% when compared to traditional use of silver ion. The composition also provides antiviral activity in water containing 1000 times wider input virus concentration range when compared with traditional use of silver ion. Finally, the composition also provides disinfection ability against gram positive bacteria.

The use of this composition has been demonstrated based on a number aspects, such as reduction in contact time required for killing, ability to kill microorganisms in presence of interfering species, activity against diverse types of microorganisms, antimicrobial activity even at low concentrations of the composition, ability to handle high concentrations of microorganisms and ability to provide sterility for water for long storage period. These properties of the composition are demonstrated through use of E. coli, S. aureus and MS2 bacteriophage as model organisms for gram negative bacteria, gram positive bacteria and virus, respectively.

In one aspect, disclosed herein is composition for purification of water by obtaining a biocidal activity in water, the composition comprising: a 5 ppb to 100 ppb transition metal ion Mⁿ⁺ releasing compound, wherein transition metal Mⁿ⁺ is silver ion (Ag⁺) and Mⁿ⁺ releasing compound is selected from the group consisting of silver nitrate, silver acetate, silver fluoride, silver sulfate, and silver nitrate; along with a 5 ppm to 100 ppm CO₃²⁻ ion releasing compound, wherein the CO₃²⁻ ion releasing compound is one of Na₂CO₃ and K₂CO₃; or a 5 ppm to 40 ppm SiO₃²⁻ ion releasing compound, wherein the SiO₃²⁻ ion releasing compound is one of Na₂SiO₃ and K₂SiO₃.

In another aspect, disclosed herein is a composition for obtaining biocidal activity in water, the composition comprising: a 5 ppb to 5 ppm transition metal ion Mⁿ⁺ releasing compound, wherein transition metal ion Mⁿ⁺ includes one or more of Fe³⁺, Zn²⁺, Cu²⁺, and Ag⁺ and wherein the Mⁿ⁺ releasing compound is selected from the group consisting of metal nitrate, metal acetate, metal fluoride, metal sulfate and silver nitrate; along with a 5 ppm to 100 ppm CO₃²⁻ ion releasing compound, wherein the CO₃²⁻ ion releasing compound is one of Na₂CO₃ or K₂CO₃; or a 5 ppm to 40 ppm SiO₃²⁻ ion releasing compound, wherein the SiO₃²⁻ ion releasing compound is one of Na₂SiO₃ or K₂SiO₃.

In one aspect, the source of silver ion includes dissolution of ion from silver releasing compound present in the form of silver nanoparticles. In another aspect, the source of silver ion includes dissolution of ion from silver releasing compound present in the form of silver electrode.

In one aspect, the composition acts as a biocide with water having chloride concentration up to 1000 ppm.

In one aspect, the composition provides disinfection ability against gram positive bacteria.

In one aspect, the composition further sterilizes drinking water for more than about 48 hour of storage.

In one aspect, the composition lowers the concentration of silver ion required at least by 60% when compared with traditional use of Ag⁺ ion for obtaining complete virus deactivation efficiency.

In one aspect, the composition further the standing time required for obtaining complete microbial deactivation efficiency at least by 50% when compared with traditional use of silver ion.

In one aspect, the composition further provides antiviral activity in water containing 1000 times wider input virus concentration range when compared with traditional use of silver ion.

Also disclosed herein is a water purification device comprising: a tank having an inlet and an outlet for passage of water therethrough; and a filtration unit present inside the tank, the filtration unit comprising: at least one filtration medium for releasing metal ion in the water; along with at least one capsule for releasing CO₃²⁻ ions in the water, wherein CO₃²⁻ ions are released by a compound comprising at least one of Na₂CO₃ and K₂CO₃; or at least one capsule for releasing SiO₃²⁻ ions in the water, wherein SiO₃²⁻ ions are released by a compound comprising at least one of Na₂SiO₃ and K₂SiO₃.

In one aspect, the filtration medium for releasing metal ion in the water comprises silver nanoparticles impregnated on organic templated boehmite nanoarchitecture.

In another aspect, the capsule is prepared by granulating finely ground Na₂CO₃.

In another aspect, wherein the capsule is housed in a see-through housing in the filtration unit.

### Experimental Methods

### Example 1

This example demonstrates the speciation of silver ion in synthetic challenge water containing various ions of relevance: (a) Cl⁻ (b) CO₃²⁻ (c) SiO₃²⁻ and (d) all ions together. The speciation diagram is prepared using simulations run on MINTEQL software version 3.0.

### Example 2

This example describes reduction in bacterial killing efficiency of the composition in comparison to silver ion in presence of sea salt. In an aspect, 100 mL of synthetic water (typically containing E. coli concentration of 1×10⁵ CFU/mL, unless otherwise mentioned) with Ag⁺ (50 ppb) and Ag⁺ (50 ppb)/CO₃²⁻ (20 ppm) was separately shaken with different concentrations of sea salt. Source of carbonate ion is chosen one amongst the following: sodium carbonate, potassium carbonate or ammonium carbonate or a combination thereof. Source of Ag⁺ is chosen one amongst the following: silver nitrate, silver acetate, silver sulfate, silver fluoride or a combination thereof. Synthetic challenge water contains all the ions as prescribed by US NSF for challenge water studies. Typically, one hour of standing time, unless otherwise mentioned, is provided for the exposure of microorganisms to the biocidal composition. After one hour of standing, 1 mL from the samples was plated along with agar on a sterile petridish using the pour plate method. After 48 h of incubation at 37° C., the colonies were counted and recorded.

### Example 3

This example describes the method of measuring the bacterial killing efficiency of the composition in comparison to silver ion, when low concentration of silver ion is used. In an aspect, 100 mL of synthetic water (typically containing bacterial concentration of 1×10⁵ CFU/mL, unless otherwise mentioned) was shaken with various combinations of silver ion and carbonate. Synthetic challenge water contains all the ions as prescribed by US NSF for challenge water studies. Source of carbonate ion is chosen one amongst the following: sodium carbonate, potassium carbonate or ammonium carbonate or a combination thereof. Source of Ag⁺ is chosen one amongst the following: silver nitrate, silver acetate, silver sulfate, silver fluoride or a combination thereof. After one hour of standing, 1 mL from the samples was plated along with agar on a sterile petridish using pour plate method. After 48 h of incubation at 37° C., the colonies were counted and recorded.

### Example 4

This example describes the method for measuring the reduction in virus killing efficiency of the composition in comparison to silver ion, when synthetic challenge water contains varying concentrations of humic acid, taken to represent organic load. In an aspect, 100 mL of synthetic water samples (typically containing bacterial concentration of 1×10⁵ CFU/mL, unless otherwise mentioned) containing varying concentrations of humic acid were separately shaken with Ag⁺(50 ppb) and Ag⁺(50 ppb)/CO₃²⁻(20 ppm). Synthetic challenge water contains all the ions as prescribed by US NSF for challenge water studies. Source of carbonate ion is chosen one amongst the following: sodium carbonate, potassium carbonate or ammonium carbonate or a combination thereof. Source of Ag⁺ is chosen one amongst the following: silver nitrate, silver acetate, silver sulfate, silver fluoride or a combination thereof. After one hour of standing, 1 mL from the samples was plated along with agar on a sterile petridish using pour plate method. After 48 h of incubation at 37° C., the colonies were counted and recorded.

### Example 5

This example describes the method of measuring the reduction in bacterial killing efficiency of the composition in comparison to corresponding transition metal ion alone. In an aspect, 100 mL of synthetic water (typically containing E-coli concentration of 1×10⁵ CFU/mL, unless otherwise mentioned) was separately shaken with Mⁿ⁺, Mⁿ⁺/CO₃²⁻ and Mⁿ⁺/SiO₃²⁻ {concentration used: copper (500 ppb), zinc (1 ppm), iron (200 ppb), silver (30 ppb), carbonate (20 ppm) and silicate (15 ppm)}. Synthetic challenge water contains all the ions as prescribed by US NSF for challenge water studies. Source of carbonate ion is chosen one amongst the following: sodium carbonate, potassium carbonate or ammonium carbonate or a combination thereof. Source of silicate ion is chosen one amongst the following: sodium silicate, potassium silicate or ammonium silicate or a combination thereof. Source of Mⁿ⁺ is chosen one amongst the following: metal nitrate, metal acetate, metal sulfate, metal fluoride or a combination thereof. If Mⁿ⁺ is not Ag⁺, then metal chloride may also be used. 1 mL of the sample was plated along with nutrient agar on a sterile petridish using the pour plate method after one hour and 24 hours. After 48 hours of incubation of plating at 37° C., the colonies were counted and recorded.

### Example 6

This example describes the method of measuring the reduction in S. aureus (MTCC 96) killing efficiency of the composition in comparison to silver ion. In an aspect, 100 mL of synthetic water (typically containing E-coli concentration of 1×10⁵ CFU/mL, unless otherwise mentioned) was separately shaken with Ag⁺ and Ag⁺/CO₃²⁻. Synthetic challenge water contains all the ions as prescribed by US NSF for challenge water studies. Source of carbonate ion is chosen one amongst the following: sodium carbonate, potassium carbonate or ammonium carbonate or a combination thereof. Source of Ag⁺ is chosen one amongst the following: silver nitrate, silver acetate, silver sulfate, silver fluoride or a combination thereof. 1 mL of the sample was plated along with nutrient agar on a sterile petridish using the pour plate method after 1 h. After 48 hours of incubation of plating at 37° C., the colonies were counted and recorded.

### Example 7

This example describes the method for measuring the sterility of stored water treated with the composition and silver ion separately. In an aspect, 100 mL of synthetic water (typically containing E-coli concentration of 1×10⁵ CFU/mL, unless otherwise mentioned) was shaken with Ag⁺, Ag⁺/CO₃²⁻ and Ag⁺/SiO₃²⁻. Synthetic challenge water contains all the ions as prescribed by US NSF for challenge water studies. Source of carbonate ion is chosen one amongst the following: sodium carbonate, potassium carbonate or ammonium carbonate or a combination thereof. Source of silicate ion is chosen one amongst the following: sodium silicate, potassium silicate or ammonium silicate or a combination thereof. Source of Ag⁺ is chosen one amongst the following: silver nitrate, silver acetate, silver sulfate, silver fluoride or a combination thereof. 1 mL of the sample was plated along with nutrient agar on a sterile petridish using the pour plate method after 1 h and 24 h. After 48 hours of incubation of plating at 37° C., the colonies were counted and recorded.

### Example 8

This example describes the effect of a representative common ions found in drinking water on the physical attributes of microorganism in water. In an aspect, 100 mL of synthetic water (typically containing bacteriophage MS2, concentration of 1×10⁶ PFU/mL in synthetic challenge water) was shaken followed by the addition of 20 ppm CO₃²⁻. Synthetic challenge water contains all the ions as prescribed by US NSF for challenge water studies. Source of carbonate ion is chosen one amongst the following: sodium carbonate, potassium carbonate or ammonium carbonate or a combination thereof. Hydrodynamic diameter of the virus was measured at each step using Horiba nanoZS particle size analyzer.

### Example 9

This example describes the method for measuring the enhancement in virus killing efficiency of the composition in comparison to silver ion. In an aspect, 100 mL of synthetic water (typically containing MS2 bacteriophage concentration of 1×10³ PFU/mL, unless otherwise mentioned) was shaken with various combinations of silver ion (20, 30 and 50 ppb) and carbonate (10, 20, 30 and 40 ppm) or silicate (5, 10 and 15 ppm). Synthetic challenge water contains all the ions as prescribed by US NSF for challenge water studies. Source of carbonate ion is chosen one amongst the following: sodium carbonate, potassium carbonate or ammonium carbonate or a combination thereof. Source of silicate ion is chosen one amongst the following: sodium silicate, potassium silicate or ammonium silicate or a combination thereof. Source of Ag⁺ is chosen one amongst the following: silver nitrate, silver acetate, silver sulfate, silver fluoride or a combination thereof. Synthetic water having the TDS between 300-500 ppm and pH=7±0.2 was used in the study. After one hour of standing, 1 mL from the samples were plated along with soft agar on a sterile petridish using plaque assay method. After 16 h of incubation at 37° C., the colonies were counted and recorded.

### Example 10

This example describes the method of measuring the kinetics of virus killing efficiency of the composition in comparison to silver ion. In an aspect, 100 mL of synthetic water (typically containing MS2 bacteriophage concentration of 1×10³ PFU/mL, unless otherwise mentioned) was separately shaken with CO₃²⁻(20 ppm), Ag⁺(50 ppb) and Ag⁺ (50 ppb)/CO₃²⁻(20 ppm). Synthetic water having the TDS between 300-500 ppm and pH=7±0.2 was used in the study. Source of carbonate ion is chosen one amongst the following: sodium carbonate, potassium carbonate or ammonium carbonate or a combination thereof. Source of Ag⁺ is chosen one amongst the following: silver nitrate, silver acetate, silver sulfate, silver fluoride or a combination thereof. 1 mL of the sample along with soft agar was plated on a sterile petridish using plaque assay method after 15 min, 30 min, 45 min and 60 min of contact time. After 16 h of incubation at 37° C., the colonies were counted and recorded.

### Example 11

This example describes the method for measuring the reduction in virus killing efficiency of the composition in comparison to silver ion, when higher virus input load is employed. In an aspect, 100 mL of synthetic water (containing 50 ppb silver and 20 ppm carbonate, unless otherwise mentioned) was shaken with increasingly higher concentration of virus (up to 10⁶ PFU/mL). Synthetic challenge water contains all the ions as prescribed by US NSF for challenge water studies. Source of carbonate ion is chosen one amongst the following: sodium carbonate, potassium carbonate or ammonium carbonate or a combination thereof. Source of Ag⁺ is chosen one amongst the following: silver nitrate, silver acetate, silver sulfate, silver fluoride or a combination thereof. After one hour of contact time, 1 mL of the sample along with soft agar was plated on a sterile petridish using plaque assay method. After 16 h of incubation at 37° C., the colonies were counted and recorded.

### Example 12

This example describes the method for measuring the reduction in virus killing efficiency of the composition in comparison to corresponding transition metal ion. In an aspect, 100 ml of synthetic water (typically containing MS2 bacteriophage concentration of 1×10³ PFU/mL, unless otherwise mentioned) was separately shaken with Mⁿ⁺, Mⁿ⁺/CO₃²⁻ and Mⁿ⁺/SiO₃²⁻ {concentration used: copper (500 ppb), zinc (1 ppm), iron (200 ppb), silver (30 ppb), carbonate (20 ppm) and silicate (15 ppm)}. Synthetic challenge water contains all the ions as prescribed by US NSF for challenge water studies. Source of carbonate ion is chosen one amongst the following: sodium carbonate, potassium carbonate or ammonium carbonate or a combination thereof. Source of silicate ion is chosen one amongst the following: sodium silicate, potassium silicate or ammonium silicate or a combination thereof. Source of Mⁿ⁺ is chosen one amongst the following: metal nitrate, metal acetate, metal sulfate, metal fluoride or a combination thereof. If Mⁿ⁺ is not Ag⁺, then metal chloride may also be used. After one hour of standing, 1 mL from the samples was plated along with soft agar on a sterile petridish using plaque assay method. After 16 h of incubation at 37° C., the colonies were counted and recorded

### Example 13

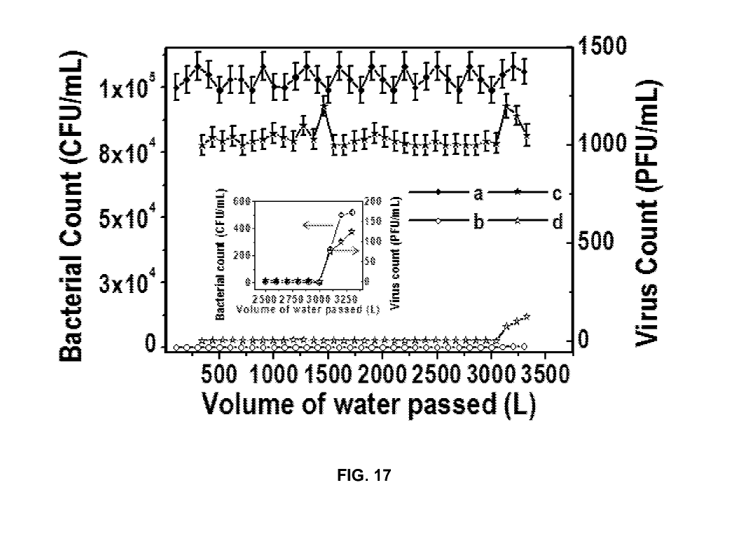

This example describes the performance of a water purification device containing the composition as shown in FIG. 17. Source of silver ion in the composition is learnt from a constant silver ion release composition (as described in 947/CHE/2011 by same inventors hereof). Source of CO₃²⁻ ion in the composition is attained by preparation of a constant release composition (further referred to as capsule) for CO₃²⁻ ion. Na₂CO₃ is used as a source for CO₃²⁻ in the preparation of the capsule. We have found that Na₂CO₃ has a unique property of self-binding on mixing with water to form a block/capsule. For the preparation of the capsule, a finely ground Na₂CO₃ is homogenized with water in a ratio of 10:1 (w/w) and granulated in a pan coating machine.

Please note that there are references for slow dissolving tablet as an indicator in water treatment application. However, such tablets are formed by mixing the indicator composition (e.g., CaSO₄ used in Indian patent application 1724/MUM/2009) with a binder/other ingredients (e.g., PVPK and magnesium stearate used in Indian patent application 1724/CHE/2009) followed by the application of compressive pressure up to 200 kg/cm². Use of binder in the preparation of the capsule therefore leads to the leaching of organic species in water.

The water purification device, for the sake of demonstration, is a one container water purifier (as described in 1522/CHE/2011 by same inventors hereof). The water purification device is run at a flow rate of 1 L/min. Synthetic challenge water having a TDS in the range of 300-500 ppm is used as feed water. Feed water is separately spiked with MS2 bacteriophage and E. coli at a concentration of 1×10³ PFU/mL and 1×10⁵ CFU/mL, unless otherwise mentioned. Output water, after an hour of standing time, is plated separately for bacterial and virus count using pour plate and plaque assay method as described in earlier examples. After 16 h (virus) and 48 h (bacteria) of incubation at 37° C., the colonies were counted and recorded.

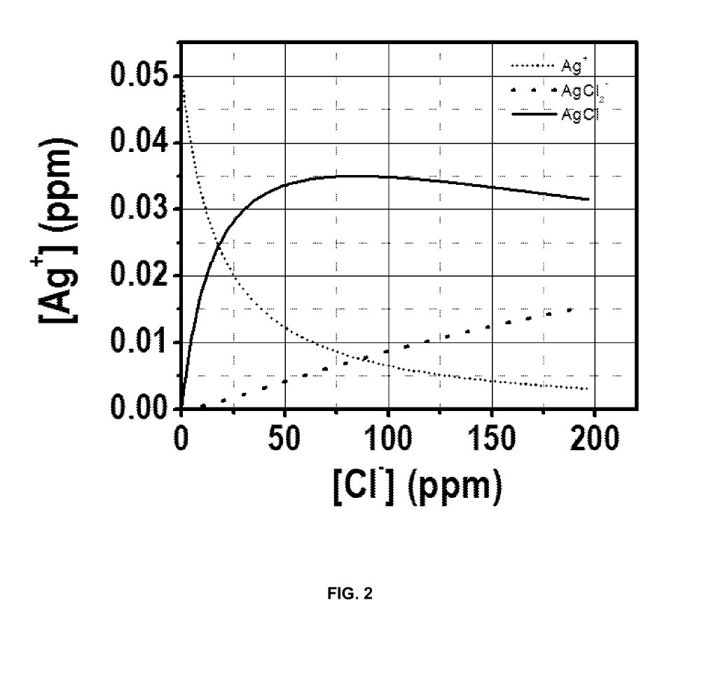

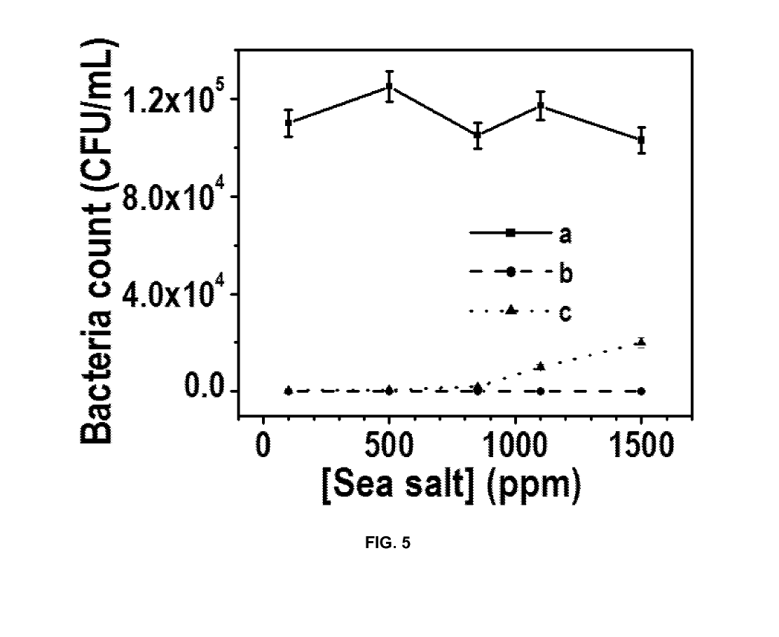

As shown in FIG. 2, chloride ion significantly affects the availability of silver ion in natural drinking water. Silver ion forms a number of complexes with chloride ion, even at a silver ion concentration as low as 50 ppb. At 100 ppm Cl⁻, it exists in the following form: 15% (Ag⁺), 70% (AgCl(aq)), 15% (AgCl₂). Conversion of Ag⁺ to AgCl(aq) reaches a maximum of 70% with Cl⁻ concentration as low as 75 ppm and doesn't reduce significantly with increasing Cl⁻ concentration. Please note that chloride-complex forms of Ag are not as effective biocides as Ag⁺, presumably because of reduced interaction of uncharged/negatively charged silver complexes with the surfaces of microorganisms. As the chloride ion concentration continues to drive up, AgCl₂⁻ concentration increases at the expense of Ag⁺. It can be therefore inferred that higher the chloride ion concentration, lower is the net Ag⁺ concentration leading to lower anti-microbial activity (demonstrated in FIG. 5).

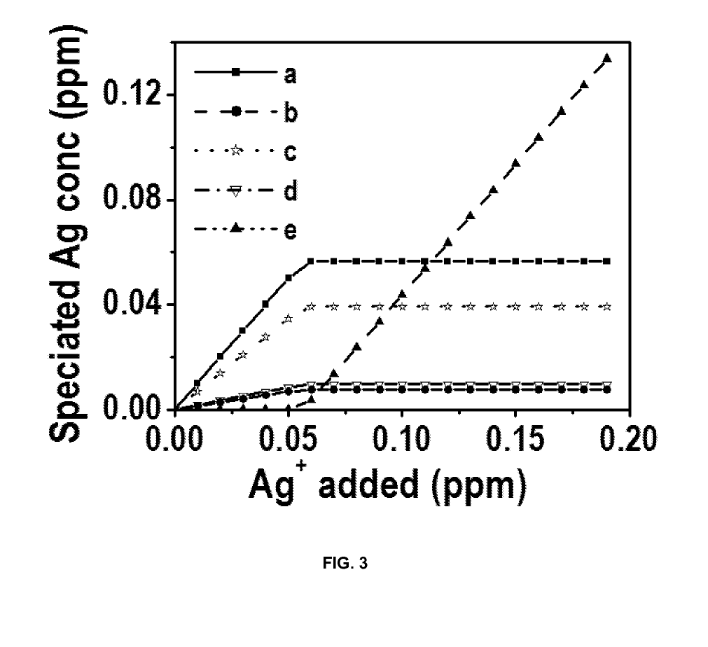

FIG. 3 explains the speciation behavior of silver with varying added silver ion concentration, by keeping chloride ion concentration constant at 100 ppm. Total dissolved silver comprises of three components: Ag⁺, AgCl(aq) and AgCl₂³¹ . It is found that total dissolved silver reaches a maximum at added silver concentration of 65 ppb. Added silver concentration above 65 ppb is of no use for drinking water application as added silver concentration beyond that value precipitates in form of AgCl(s), and therefore, has negligible antimicrobial activity. Beyond an added silver concentration of 65 ppb, individual components of total dissolved silver concentration stays nearly constant at 55 ppb and active Ag⁺ concentration stays nearly constant at 7 ppb. It can therefore be inferred that for each chloride ion concentration, there is a maximum limit of added silver concentration beyond which silver precipitates, i.e., there is a limited available concentration window for silver's antimicrobial activity.

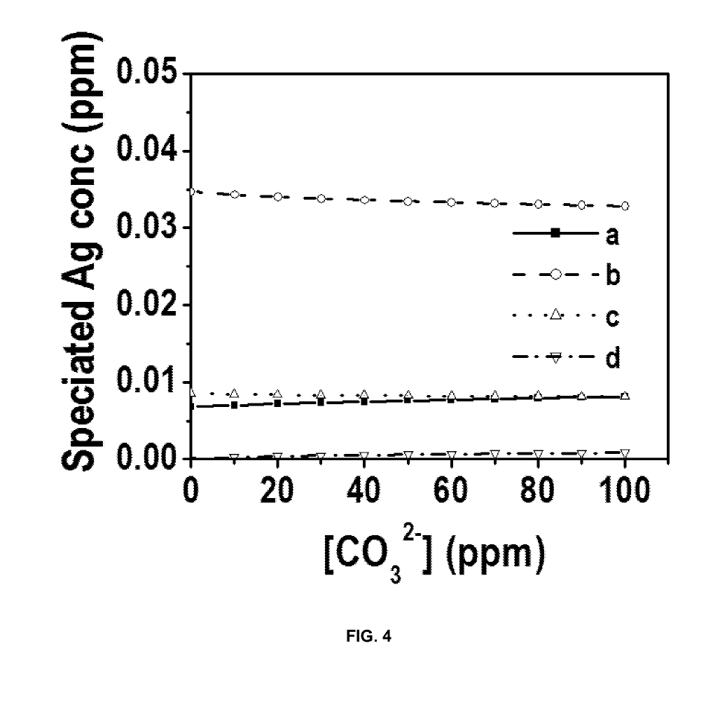

FIG. 4 describes the role of CO₃²⁻ in altering the speciation of silver ion in water. It can be seen that CO₃²⁻ doesn't negatively affect the overall speciation diagram of silver and silver ion speciation continues to be guided by the concentration of Cl⁻. Actually, over a CO₃²⁻ concentration window of 0-100 ppm, free silver ion concentration increases from 7 to 8 ppb whereas other less potent forms (such as AgCl(aq.) and AgCl₂) decrease in the concentration. Building the speciation diagram for actual drinking water is complex due to the involvement of several ionic species, however, it is possible that CO₃²⁻ increases the concentration of free silver ion which in turns leads to positive enhancement in antimicrobial activity. Formation of other silver complexes (such as AgOH) is low until CO₃²⁻ concentration reaches 100 ppm. It can therefore be inferred that CO₃²⁻ ion increases the availability of silver ion, possibly through increasing active silver ion concentration or by reducing the concentration of interfering species.

FIG. 5 demonstrates significantly improved disinfection ability of the composition over traditionally used Ag⁺. Study is conducted in synthetic challenge water prepared with varying concentrations of sea salt (as per the specification of P231 prescribed by US NSF). Input bacterial concentration taken was 1×10⁵ CFU/mL. It is observed that when the sea salt concentration was 850 ppm and Ag⁺ was 50 ppb, the output bacterial count was 2000 CFU/mL which jumped to 10,000 CFU/mL when sea salt concentration was 1100 ppm. On the contrary, synthetic challenge water with similar sea salt concentration along with the composition (Ag⁺(50 ppb)/CO₃²⁻(20 ppm)) shows bacterial counts of 2 and 5 CFU/mL. This illustrates the significant improved disinfection ability achieved by the composition when compared to Ag⁺ alone. Please note that sea salt contains a large concentration of chloride ion (Cl⁻ is over 40% w/w of various salts used for the preparation of sea salt) (reference for sea salt concentration: ASTM D1141-98). This means that active Ag⁺ concentration will be severely affected by the presence of excessive chloride ion. It can therefore be inferred that the antibacterial activity of the composition prepared with Ag⁺/CO₃²⁻ doesn't suffer from the severe negative effect of chloride ion, which is unlike the antibacterial activity of silver ion.

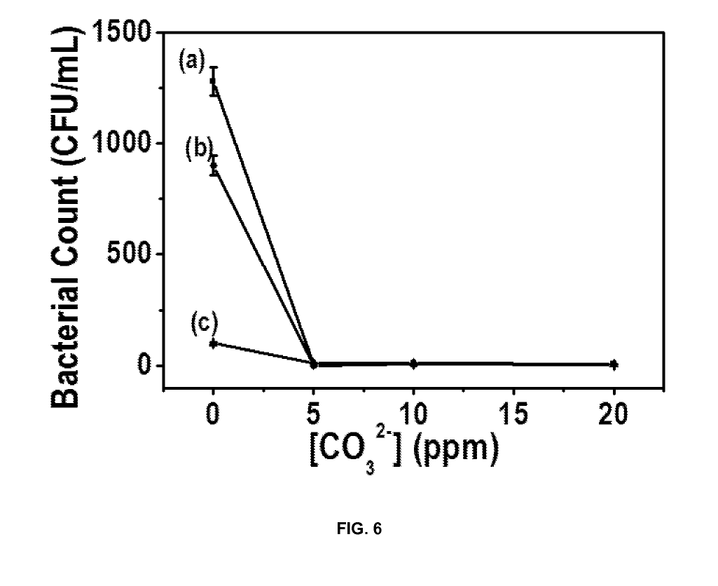

FIG. 6 demonstrates significantly improved disinfection ability of the composition (Ag⁺/CO₃²⁻) over traditionally used Ag⁺ when further reduced concentration of Ag⁺ was used. Silver's antibacterial property is well-documented and is also covered in 947/CHE/2011 and 1522/CHE/2011, by the same inventors hereof. It is now understood that minimum concentration of silver necessary for antibacterial activity is in the range of 40-50 ppb. FIG. 6 explains that below that concentration range of silver ion, an antibacterial activity of 2-3 log reduction alone is possible. It is also observed that with the use of 50 ppb Ag⁺, a residual bacterial count of 10-50 CFU/mL stays viable. However, with the composition, a number of new observations are found. Viable bacterial count reaches a value of 0-10 CFU/mL even at 20-30 ppb Ag⁺/10-20 ppm CO₃². Please note that CO₃²⁻ by itself doesn't provide a significant reduction in bacterial count. It is established that 10-20 ppm CO₃²⁻ may be used for optimum performance. It can therefore be inferred that the composition prepared with Ag⁺/CO₃²⁻ ion requires at least 50% reduced quantity of Ag⁺ compared with the traditional use of Ag⁺ for obtaining complete bacterial deactivation efficiency.

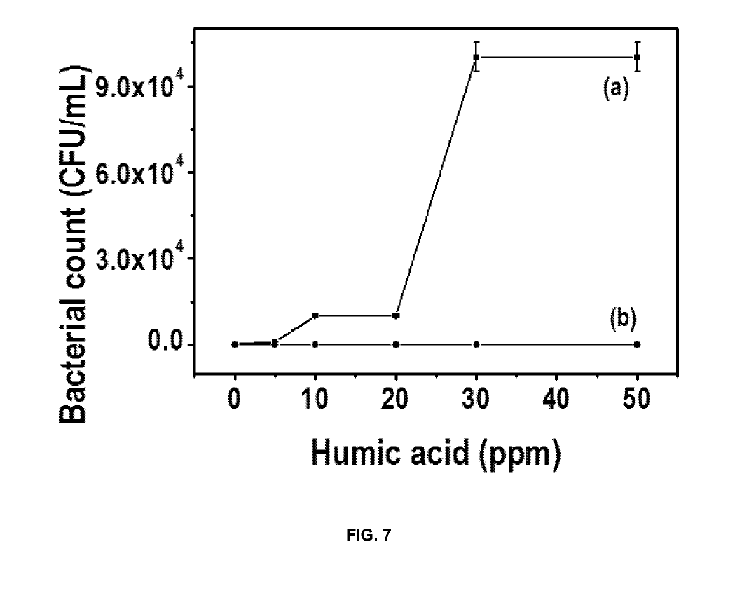

FIG. 7 demonstrates significantly improved disinfection ability of the composition (Ag⁺/CO₃²⁻) over traditionally used Ag⁺ when the test water contains high organic concentration. It is observed that 50 ppb Ag⁺ can handle bacterial count in presence of up to 5 ppm humic acid. With increase in humic acid concentration, antibacterial activity of silver undergoes gradual decline and output count reaches near to the input concentration at a humic acid concentration of 50 ppm. However, the composition (Ag⁺/CO₃²⁻) can result in high bacteria killing efficiency even when the humic acid concentration is 50 ppm. An output count of 0-15 CFU/mL is obtained as humic acid concentration is increased to 30 ppm and output count of 60 CFU/mL is obtained in presence of a humic acid concentration of 50 ppm. It can therefore be inferred that composition prepared with Ag⁺/CO₃²⁻ can provide antibacterial activity in water containing 5 times larger humic acid concentration when compared to traditional use of Ag⁺, without compromising on output water quality.

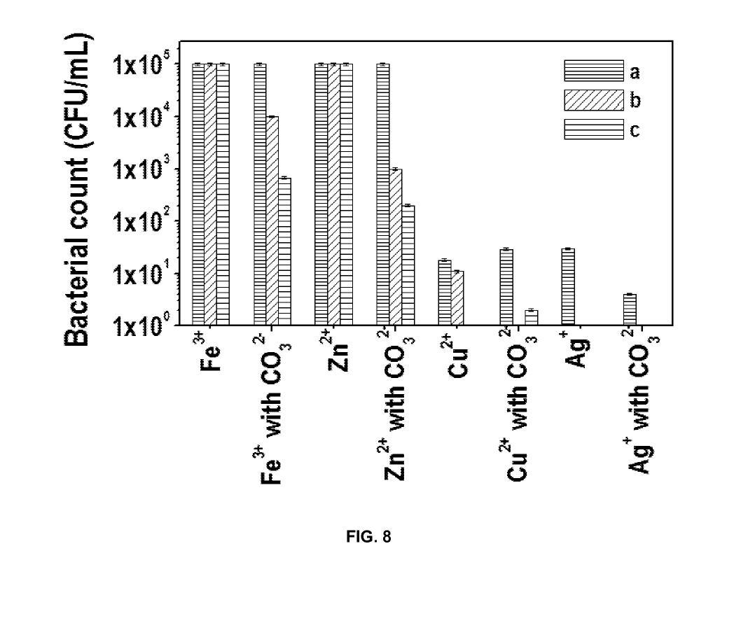

FIG. 8 demonstrates significantly improved disinfection ability of the composition (Mⁿ⁺/CO₃²⁻) over traditionally used Mⁿ⁺. It shows that the composition may not be prepared not only with silver ion but with other transition metal ions too. As it is well known, Fe³⁺ does not offer any reduction in bacterial count. However, with the composition (Fe³⁺/CO₃²⁻), two log reduction in bacterial count is observed. Likewise, in the case of another compositions based on transition metal ion (Zn²⁺/CO₃²⁻), three log reduction in bacterial count is observed. In case of another compositions based on transition metal ion (Cu²⁺/CO₃²⁻), viable bacterial count goes to 0 after a standing time of 3 h. This demonstrates the valuable antimicrobial property of Cu²⁺/CO₃². It can therefore be inferred that composition prepared with Mⁿ⁺/CO₃²⁻, wherein Mⁿ⁺ refers to transition metal ions, can provide antibacterial activity and Cu²⁺/CO₃²⁻ and Cu²⁺/SiO₃²⁻ can be used as effective antibacterial agents.

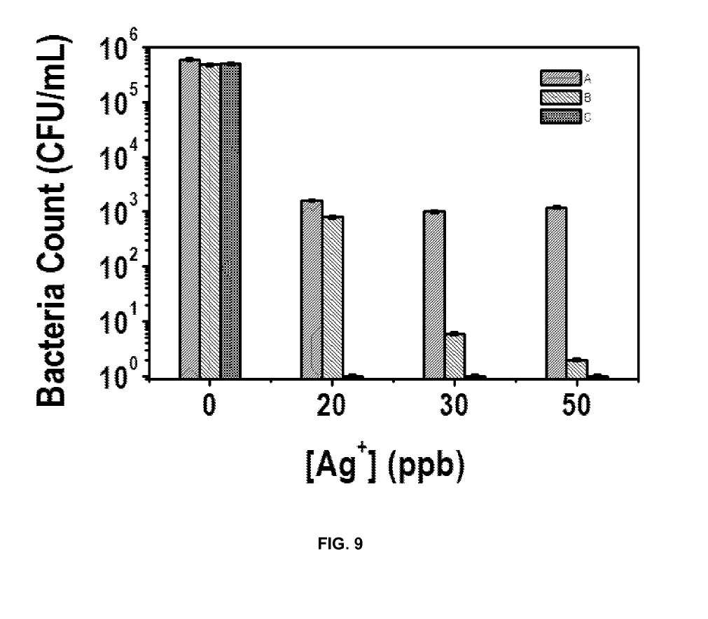

FIG. 9 demonstrates significantly improved disinfection ability of the composition (Ag⁺/CO₃²⁻) over traditionally used Ag⁺ when the test water contains gram positive bacteria. It is well known through prior art that silver ion is not a good disinfection agent for gram-positive bacteria (Woo Kyung Jung et al., Appl Environ Microbiol, 2008, 74(7), 2171-2178). 50 ppb of silver ion dose takes over 24 h to inactivate S. aureus (input concentration: 10⁷ CFU/mL). A similar behavior is observed in the data presented in FIG. 9. Use of silver ion concentration up to 50 ppb doesn't reduce S. aureus concentration to below 10³ CFU/mL after a standing period of 1 h. Please note that CO₃²⁻ doesn't act as an antibacterial agent for gram-positive bacteria as viable bacteria count after treatment with 20 ppm CO₃²⁻ stays near to the input value (>10⁵ CFU/mL). On the contrary, synthetic challenge water with the composition (Ag⁺/CO₃²⁻) shows a gradual decrease in the viable bacterial count after 1 h standing time. For the composition prepared with a combination of 30 ppb Ag⁺ and 20 ppm CO₃²⁻, viable bacteria count reduces to 6 CFU/mL. For the composition prepared with a combination of 50 ppb Ag⁺ and 20 ppm CO₃²⁻, viable bacteria count reduces to 2 CFU/mL. Please note that sterility of water after 24 h storage is maintained with use of the composition. This illustrates a significant advantage associated with the use of the composition for obtaining high antibacterial activity against gram positive bacteria. It can therefore be inferred that the composition provides the ability to handle gram positive bacteria, which hitherto is not known to happen with the use of 50 ppb Ag⁺ alone.

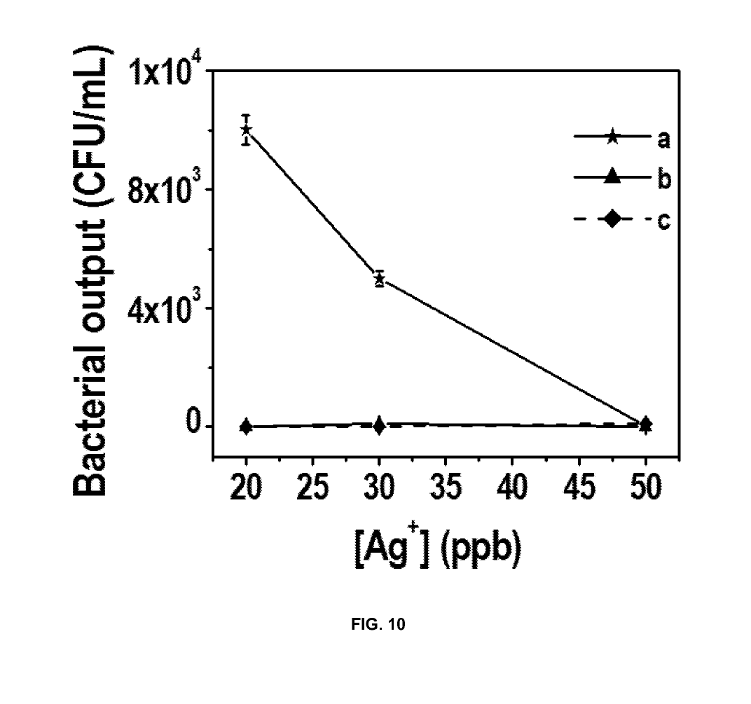

FIG. 10 demonstrates the important role played by the composition (Ag⁺/CO₃²⁻) in ensuring sterility of water even after a period of storage. It is well known that presence of silver ion in water provides sterility to the water for a long period of storage. Presence of silver ion in water inhibits the growth of microorganisms (both heterotropic plate count as well as pathogenic microorganisms). As can be seen in FIG. 10, when the silver ion concentration is at 50 ppb, bacterial count in the water after 24 h of storage is at 0 CFU/mL. However, at lower silver concentrations, bacterial count increases to >10³ CFU/mL after 24 h of storage. However, with the composition (Ag⁺/CO₃²⁻ or Ag⁺/SiO₃²⁻) provides sterility to water for 24 h of storage time, even when lower concentration of Ag⁺ is used in the preparation of the composition. This is an important aspect of the composition to provide sterile water even after long period of storage time when very low concentration of Ag+ is used for the preparation of the composition. It can therefore be inferred that the composition displays stronger ability when compared with traditional use of Ag⁺, to provide sterile drinking water even after long period of storage.

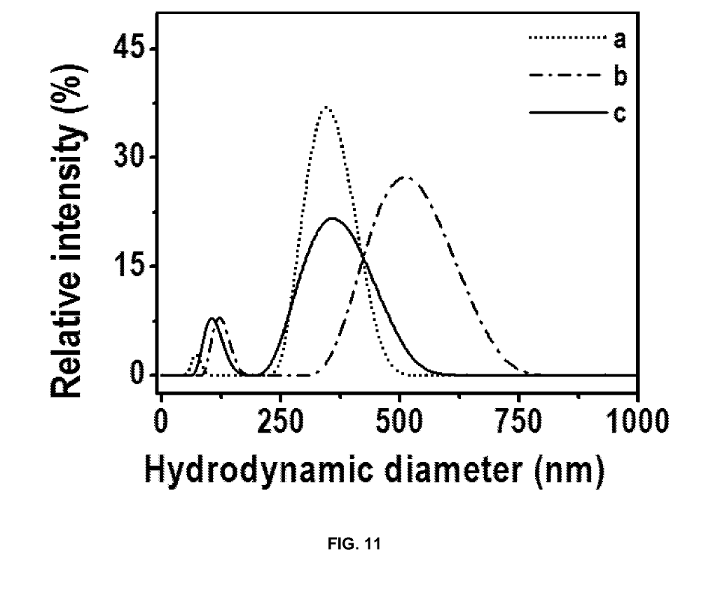

FIG. 11 illustrates another possible reason for CO₃²⁻ in enabling kill-ability of viruses present in drinking water. It is well-known from the prior art that virus is prone for aggregation induced by various parameters such as pH, ionic strength and presence of ions. Disinfection of aggregated viruses is far more difficult compared to dispersed viruses (Moritz Brennecke, Master's thesis, Disinfection Kinetics of Virus Aggregates of Bacteriophage MS2, Ecole Polytechnique Federale de Lausanne (EPFL), June 2009; M Grant, Stanley B., J. Environ. Engg., 1995, 121, 311-319). FIG. 11 illustrates hydrodynamic diameter measurement using dynamic light scattering technique of virus present in deionized water, virus present in synthetic challenge water and virus present in synthetic challenge water containing 20 ppm CO₃²⁻. It is observed that virus in de-ionized water shows two features (at 103 and 360 nm) whereas in synthetic challenge water, virus undergoes aggregation and shows two features at 122 and 514 nm. On addition of 20 ppm CO₃²⁻, de-aggregation of virus is induced and size features return to original values. It can therefore be inferred that CO₃²⁻ may be participating in inducing de-aggregation of virus in synthetic challenge water which enables easier killing of viruses by low concentration disinfection agents such as silver.

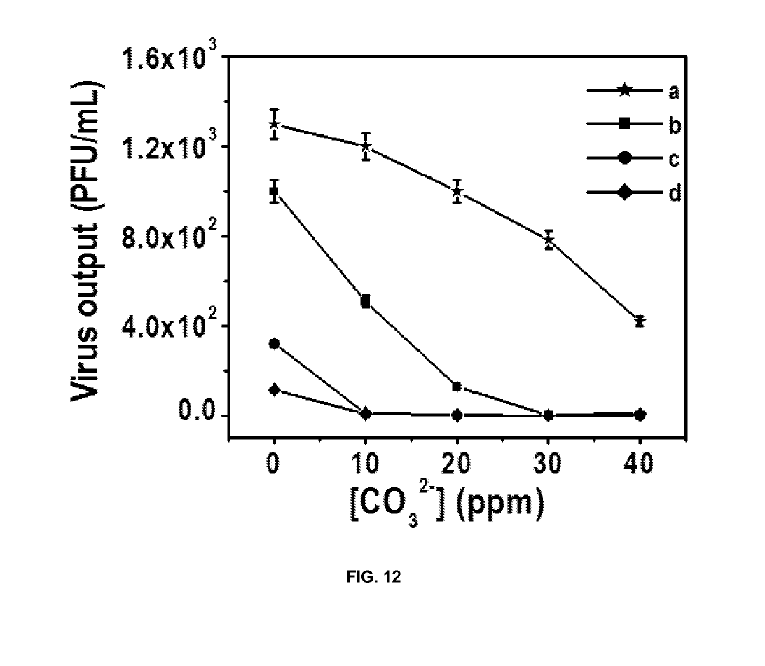

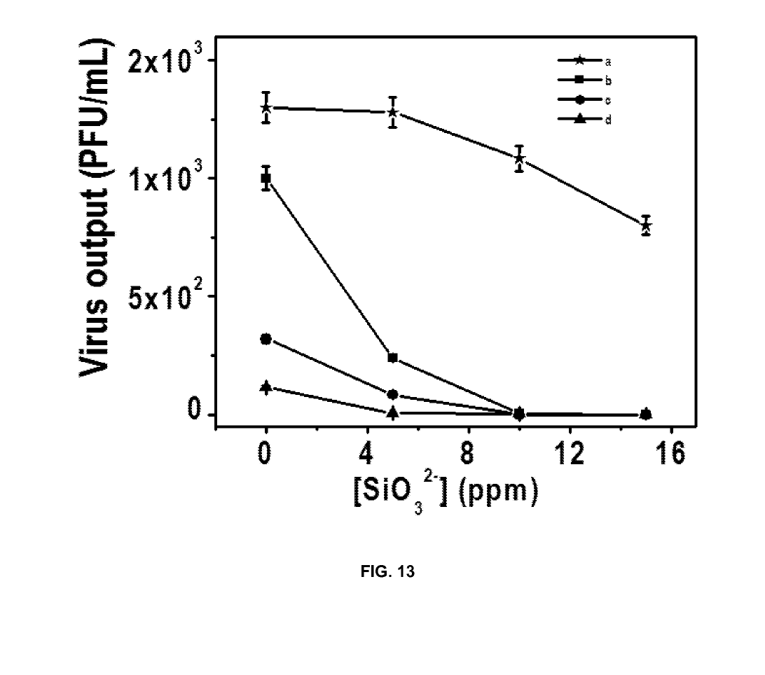

FIGS. 12 and 13 demonstrate significantly improved antiviral ability of the composition (Ag⁺/CO₃²⁻) over traditionally used Ag⁺. The improvement is demonstrated by the use of low concentration of silver ion for antiviral activity. It is established that both anions exhibit certain degree of antiviral activity, which improves with increasing anion concentration. At 20 ppm CO₃²⁻ and 10 ppm SiO₃²⁻, virus killing efficiency of 25% is obtained. The composition provides significantly improved antiviral activity when compared with similar concentration of Ag⁺. Please note that virus killing ability of the composition (Ag⁺/CO₃²⁻ or Ag⁺/CO₃²⁻) is not through additive ability of individual components. Upon addition of progressive concentrations of silver ion, higher virus killing efficiency is obtained and at a combination of 20 ppb Ag and 10 ppm SiO₃²⁻or 30 ppm CO₃²⁻, complete virus killing is achieved. Please note that residual virus concentration is present even with higher silver ion concentration (without SiO₃²⁻or CO₃²⁻). It can therefore be inferred that the composition prepared with Ag⁺/CO₃²⁻or Ag⁺/SiO₃²⁻ requires only about 60% reduced quantity of silver ion compared with traditional use of Ag⁺ for obtaining complete virus deactivation efficiency.

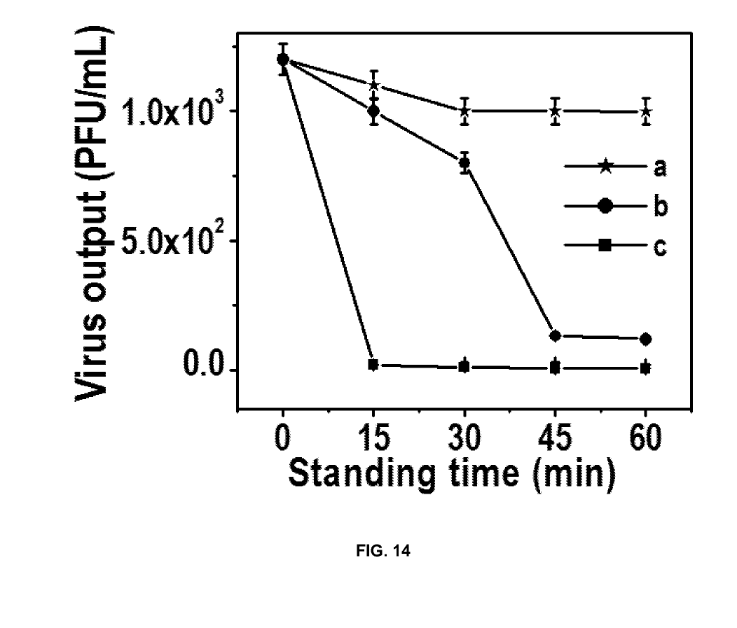

FIG. 14 demonstrates that the composition (Ag⁺/CO₃²⁻) offers significant improvement in the standing time required for antiviral activity when compared with traditional use of Ag⁺. With 20 ppm CO₃²⁻, virus killing efficiency of 20% is obtained after a standing time of 1 h. Virus killing efficiency by silver alone also reaches a saturation value in 1 h. However, with the composition (Ag⁺/CO₃²⁻), nearly complete virus killing efficiency is obtained in 15 minutes and complete virus killing efficiency is obtained in 30 minutes. This is extremely fast killing rate for disinfection agents used in such low concentration. Please note that virus killing ability of Ag⁺/CO₃²⁻ is not through additive ability of individual components. It can therefore be inferred that the composition offers complete virus deactivation efficiency in at least 50% lower standing time when compared with traditional use of Ag⁺.

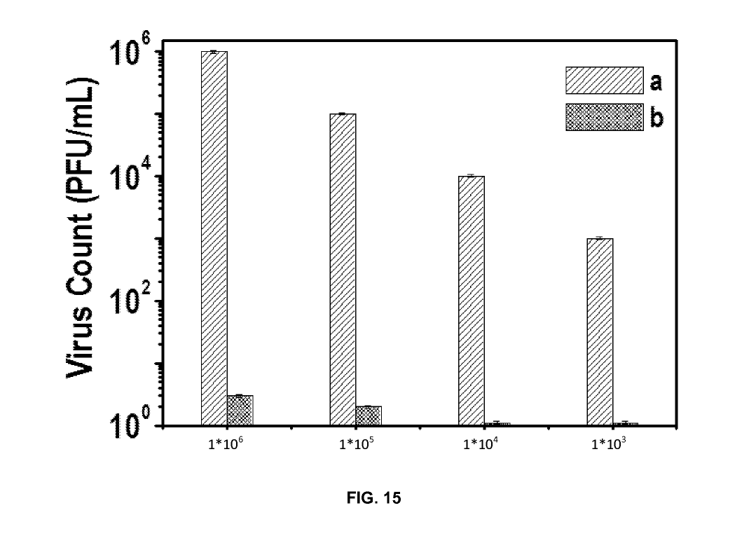

FIG. 15 demonstrates significantly improved antiviral ability of the composition (Ag⁺/CO₃²⁻) over traditionally used Ag⁺ when the test water contains higher input load of virus. Usually silver ion alone is unable to obtain complete virus killing ability for input virus concentration higher than 10³ PFU/mL. However, the composition (Ag⁺/CO₃²⁻) can obtain high virus killing efficiency even when input virus concentration is 10⁶ PFU/mL. An output count of 0-3 PFU/mL is obtained as input concentration is changed from 10³ to 10⁶ PFU/mL. It can therefore be inferred that the composition can provide antiviral activity in 1000 times higher operating concentration range of virus when compared with traditional use of Ag⁺, without compromising on output water quality.

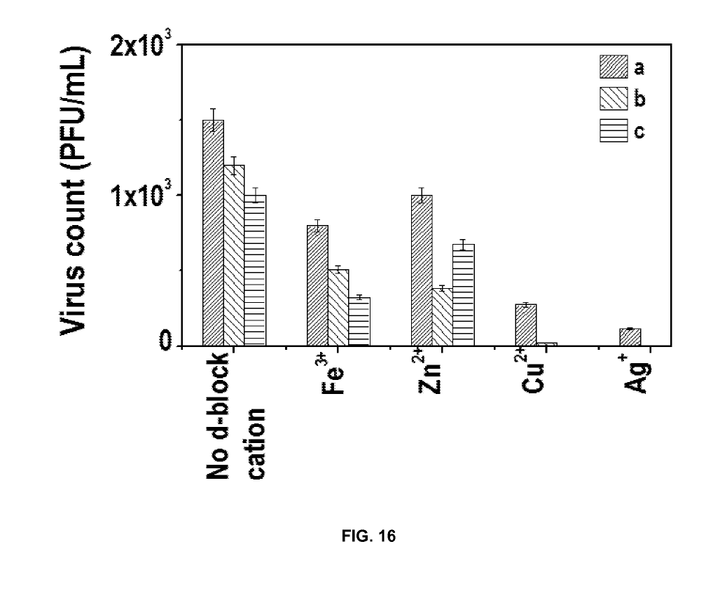

FIG. 16 demonstrates significantly improved antiviral ability of the composition (Mⁿ⁺/CO₃²⁻) over traditionally used Mⁿ⁺. It shows that the composition may be prepared not only with silver ion but with other transition metal ions too. For example, Fe³⁺ (500 ppb) is not known to be an antimicrobial agent. However, with the composition (Fe³⁺/CO₃²⁻ or Fe³⁺/SiO₃²), reduction in viable virus count is observed, though output count doesn't reach 0. Similar behavior is observed for another compositions based on transition metal ion (Zn²⁺/CO₃²⁻ or Fe³⁺/SiO₃²⁻). It is interesting to see that another composition (Cu²⁺/CO₃²⁻ or Cu²⁺/SiO₃²⁻) provides significant improvement in antiviral properties of Cu²⁺. Considering the fact the cost of copper is 150 times cheaper than silver and with the required copper dose of 500 ppb (20×vis-à-vis silver dose of 25 ppb), a cost reduction factor of 7 can be obtained for the antimicrobial agent. It can therefore be inferred that composition prepared with Mⁿ⁺/CO₃²⁻ or Mⁿ⁺/SiO₃²⁻, wherein Mⁿ⁺ refers to transition metal ions, can provide antiviral activity and Cu²⁺/CO₃²⁻and Cu²⁺/SiO₃²⁻can be used as effective antiviral agents.

FIG. 17 explains the use of the composition in the form of a device as an antibacterial and antiviral agent. The aspect of preparation of a constant release capsule for CO₃²⁻ is described in example 13 and is combined with a constant release composition for silver ion (947/CHE/2011) to obtain a water purification device operated for use in a water purifier (1522/CHE/2011). It is observed that upon passage of water through the device, nearly constant release of silver ion at 50 ppb and CO₃²⁻ ion at 20 ppm is achieved for prolonged run of the device. This manifests in the form of excellent biocidal activity for the water purification device over a period of 3000 L. Please note that microbial spiking in the challenge water is done every 100 L so that biocidal composition is constantly subjected to organic and salt load. Upon passage of 3000 L of water, it is observed that output bacterial count increases steadily as the CO₃²⁻ capsule has nearly exhausted (visibly measurable through physical dimension of the capsule) which acts as a signal for replenishment. The need for replenishment is reflected through the increase in the bacterial and viral count in the output water after the passage of 3000 L, at which the capsule has visibly exhausted. It can therefore be inferred that water purification device prepared with the composition can provide simultaneous enhanced activity and a visible measurement for useful life.

This demonstrates the application of the biocidal composition as an effective water purification device.

The described aspects are illustrative of the invention and not restrictive. It is therefore obvious that any modifications described in this invention, employing the principles of this invention without departing from its spirit or essential characteristics, still fall within the scope of the invention. Consequently, modifications of design, methods, structure, sequence, materials and the like would be apparent to those skilled in the art, yet still fall within the scope of the invention.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A composition for purification of water by obtaining a biocidal activity in water, the composition comprising:
a 5 ppb to 100 ppb transition metal ion Mⁿ⁺ releasing compound, wherein transition metal Mⁿ⁺ is silver ion (Ag⁺) and Mⁿ⁺ releasing compound is selected from the group consisting of silver nitrate, silver acetate, silver fluoride, silver sulfate, and silver nitrate; along with
a 5 ppm to 100 ppm CO₃²⁻ ion releasing compound, wherein the CO₃²⁻ ion releasing compound is one of Na₂CO₃ and K₂CO₃; or
a 5 ppm to 40 ppm SiO₃²⁻ ion releasing compound, wherein the SiO₃²⁻ ion releasing compound is one of Na₂SiO₃ and K₂SiO₃.

2. The composition as claimed in claim 1, wherein the Mⁿ⁺ releasing compound comprises silver nanoparticles, and wherein silver ion is derived from dissolution of the Mⁿ⁺ releasing compound.

3. The composition as claimed in claim 1, wherein the Mⁿ⁺ releasing compound comprises a silver electrode, and wherein silver ion is derived from dissolution of the Mⁿ⁺ releasing compound.

4. The composition as claimed in claim 1, wherein the composition acts as a biocide with water having chloride concentration up to 1000 ppm.

5. The composition as claimed in claim 1, wherein the composition provides disinfection ability against gram positive bacteria.

6. The composition as claimed in claim 1, wherein the composition can sterilize drinking water for more than about 48 hours of storage.

7. The composition as claimed in claim 1, wherein the composition lowers the concentration of silver ion required at least by 60%, when compared with traditional use of Ag⁺ ion for obtaining complete virus deactivation efficiency.

8. The composition as claimed in claim 1, wherein the composition decreases the standing time required for obtaining complete microbial deactivation efficiency at least by 50%, when compared with traditional use of silver ion.

9. The composition as claimed in claim 1, wherein the composition further provides antiviral activity in water containing 1000 times wider input virus concentration range, when compared with traditional use of silver ion.

10. A composition for obtaining biocidal activity in water, the composition comprising:
a 5 ppb to 5 ppm transition metal ion Mⁿ⁺ releasing compound, wherein transition metal ion Mⁿ⁺ includes one or more of Fe³⁺, Zn²⁺, Cu²⁺, and Ag⁺ and wherein the Mⁿ⁺ releasing compound is selected from the group consisting of metal nitrate, metal acetate, metal fluoride, metal sulfate and silver nitrate; along with
a 5 ppm to 100 ppm CO₃²⁻ ion releasing compound, wherein the CO₃²⁻ ion releasing compound is one of Na₂CO₃ or K₂CO₃; or
a 5 ppm to 40 ppm SiO₃²⁻ ion releasing compound, wherein the SiO₃²⁻ ion releasing compound is one of Na₂SiO₃ or K₂SiO₃.

11. A water purification device comprising:
a tank having an inlet and an outlet for passage of water therethrough; and
a filtration unit present inside the tank, the filtration unit comprising:
at least one filtration medium for releasing metal ion in the water; along with
at least one capsule for releasing CO₃² ions in the water, wherein CO₃²⁻ ions are released by a compound comprising at least one of Na₂CO₃ and K₂CO₃; or
at least one capsule for releasing SiO₃²⁻ ions in the water, wherein SiO₃²⁻ ions are released by a compound comprising at least one of Na₂SiO₃ and K₂SiO₃.

12. The water purification device of claim 11, wherein the filtration medium for releasing metal ion in the water comprises silver nanoparticles impregnated on organic templated boehmite nanoarchitecture.

13. The water purification device of claim 11, wherein the capsule is prepared by granulating finely ground Na₂CO₃.

14. The water purification device of claim 11 any one of claims 11-13, wherein the capsule is housed in a see-through housing in the filtration unit.
